(19) United States
(12) Patent Application Publication
(10) Pub. No.: US 2026/0043197 A1
(43) Pub. Date: Feb. 12, 2026

(54) MULTI-PLY LAMINATION IN A SINGLE LAMINATION STACK

(71) Applicant: GPCP IP Holdings LLC, Atlanta, GA (US)

(72) Inventor: Lars N. Nordang, Neenah, WI (US)

(21) Appl. No.: 19/104,236

(22) PCT Filed: Jul. 21, 2023
(86) PCT No.: PCT/IB2023/057444

§ 371 Date: Feb. 17, 2025

Related U.S. Application Data
(60) Provisional application No. 63/371,988, filed on Aug. 19, 2022.

(51) Int. Cl. D21H 27/32; B32B 7/12; B32B 29/00; B32B 37/00; B32B 37/12; B32B 38/06

(52) U.S. Cl. CPC D21H 27/32; B32B 7/12; B32B 29/005; B32B 37/0053; B32B 37/1284; B32B 38/06; B32B 2250/26; B32B 2307/536; B32B 2307/718; B32B 2309/14

(57) ABSTRACT

Disclosed herein are methods for manufacturing multi-ply paper products, such as napkins, towels, tissues, and wipers are disclosed. More particularly, methods of manufacturing a multi-ply paper product having at least three plies by controlling a combination of process variables, including at least anilox speed, adhesive solids, and adhesive applicator roll nip gap. Multi-ply paper products having at least three cellulosic fibrous plies with improved ply bonding between the first, second, and third plies are also disclosed.

### RELATED APPLICATIONS

This application claims priority to U.S. Provisional Application No. 63/371,988, filed Aug. 19, 2022, the contents of which are incorporated by reference herein in their entirety.

### FIELD OF INVENTION

Methods for manufacturing multi-ply paper products, such as napkins, towels, tissues, and wipers are disclosed. More particularly, methods of manufacturing a multi-ply paper product having at least three plies in a single lamination stack. Multi-ply paper products having at least three cellulosic fibrous plies with improved ply bonding between the first, second, and third plies are also disclosed.

### BACKGROUND

Consumers' daily lives are filled with a variety of modern products that are produced solely for their comfort and convenience. Absorbent paper goods take a prominent place in the list of the most used modern conveniences. Typical paper products used by consumers daily include, for example, napkins, paper towels, toilet tissues, facial tissues, wipers, and the like. In the current market where high-end absorbent paper products demand premium prices, consumers are very particular about the products for which they will pay a premium price.

Product attributes are imparted to paper products both during production of the cellulosic fibrous plies, as well as during converting operations such as laminating that are used to bond the cellulosic fibrous plies together into the final product. As the use of more plies has become common place in the production of premium products, different methods of laminating have been developed with the goal to improve one or more product attributes.

In the manufacture of two-ply paper products, a single “stage” or “stack” of rolls is often used to join, laminate, and/or emboss the two plies together. Such a single “stage” or “stack” is referred to herein as a “lamination stack,” wherein a single “lamination stack” as used herein refers to a series of rolls that at least serve the function of laminating at least two plies together, wherein the rolls are interconnected such that each roll in the stack directly interacts with at least one other roll in the same stack.

In the manufacture of paper products having three (or more) plies, two (or more) lamination stacks are often used, with two plies joined, laminated, and/or embossed in a first lamination stack and a third ply added and joined, laminated, and/or embossed to the first two plies in a second lamination stack. Additional plies may further by joined, laminated, and/or embossed in additional lamination stacks. Unfortunately, the use of two or more lamination stacks increases not only the financial investment needed to manufacture a product, but also the footprint needed for such equipment in a facility. Moreover, the attributes of the final product, such as strength, stretch, caliper, absorbency, plybond, and aesthetics are often impacted by the number of lamination stacks used. As such, new single stack lamination systems and methods are still desired to obtain multi-ply paper products with beneficial combinations of properties, and in particular multi-ply products having at least three plies.

It has surprisingly been found that multi-ply paper products having at least three plies may beneficially be formed by methods using a single lamination stack by controlling a combination of process variables, including at least anilox speed, adhesive solids, and applicator gap width. Such methods may also result in multi-ply paper products having at least three cellulosic fibrous plies with improved ply bonding between the first, second, and third plies.

### SUMMARY OF THE INVENTION

Methods for manufacturing a multi-ply paper product having at least three cellulosic fibrous plies are disclosed herein. The methods comprise forming at least three cellulosic fibrous plies on a papermaking machine; conveying a first ply and a second ply together through a first nip between an adhesive applicator roll and a second roll at a line speed, the nip having a gap between the two rolls of from about 0.000 inches to about 0.0035 inches; transferring an adhesive having a solids content of from about 6% to about 10% from an anilox roll to the adhesive applicator roll, wherein the anilox roll is rotated at a speed from about 50% to about 100% of the line speed; transferring the adhesive from the adhesive applicator roll to a first surface of the second ply at the first nip, whereby some portion of the adhesive remains on the first surface of the second ply and some portion of the adhesive is driven though the width of the second ply to the second surface of the second ply and forms a first adhesive bond between the first ply and the second ply; and conveying the first and second cellulosic fibrous plies and a third cellulosic fiber ply together through a second nip between the second roll and a third roll, whereby the third ply is adjacent to the second ply and some portion of the adhesive remaining on the first surface of the second ply forms a second adhesive bond between the second ply and the third ply.

Also described herein are multi-ply paper product comprising at least three cellulosic fibrous plies, wherein a first ply and a second ply are bonded together by a first adhesive bond, wherein the second ply and a third ply are bonded together by a second adhesive bond, wherein the first adhesive bond has a plybond between a range of from about 5 to about 50 grams force per 3 inches, and wherein the second adhesive bond has a plybond of within about 5 grams force per 3 inches of the plybond of the first adhesive bond.

The multi-ply paper products disclosed herein may be napkins, paper towels, toilet tissues, facial tissues, wipers (such as pet wipes), hand towels, placemats, and the like. In some embodiments, the multi-ply paper products may be folded products, such as a napkin, facial tissue, or wiper. In some embodiments, the multi-ply paper products may be rolled products, such as a paper towel, toilet tissue, or pet wipe.

### BRIEF DESCRIPTION OF THE DRAWINGS

FIGS. 1A and 1B are schematics of exemplary lamination stacks according to embodiments of the disclosure.

FIG. 2 illustrates a cross section of an exemplary multi-ply product, according to one embodiment of the disclosure.

FIGS. 3A and 3B illustrate transfer of an adhesive through a middle ply, according to one embodiment of the disclosure.

### DETAILED DESCRIPTION OF PREFERRED EMBODIMENTS

Reference will now be made in detail to certain exemplary embodiments, examples of which are illustrated in the accompanying drawings. Wherever possible, the same reference numbers will be used throughout the drawings to refer to the same or like items.

The present disclosure includes methods of manufacturing multi-ply paper products, as well as multi-ply paper products. The term “ply,” as used herein, refers to a monolithic or stratified fibrous structure that is integrally formed on a papermaking machine. The term “ply” may also be referred to as a “web,” “nascent web,” “tissue,” “sheet,” “base sheet,” or “tissue sheet,” which terms can be used interchangeably to refer to the ply during various stages of its development. Nascent web, for example, is often used to refer to the embryonic web that is deposited on the forming wire. Once the web achieves less than about 30% solids content, it is often referred to as a tissue or a sheet. Post-production, and prior to converting, the ply is often called a base sheet. A base sheet may be combined with other base sheets to form a multi-ply paper product.

The fibrous plies for use in the products of the present disclosure may be made from any art recognized fibers. Papermaking fibers used to form the absorbent products of the present disclosure include cellulosic fibers, commonly referred to as wood fibers. Specifically, the base sheet of the disclosure can be produced from hardwood (angiosperms or deciduous trees) or softwood (gymnosperms or coniferous trees) fibers, and any combination thereof. Hardwood fibers include, but are not limited to maple, birch, aspen and eucalyptus. Hardwood fibers generally have a fiber length of about 2.0 mm or less. Softwood fibers include, but are not limited to, spruce and pine. Softwood fibers exhibit an average fiber length of about 2.5 mm. Cellulosic fibers from diverse material origins may also be used to form the web of the present disclosure. The web of the present disclosure may also include recycle or secondary fiber. The products of the present disclosure can also include synthetic fibers as desired for the end product. The term “cellulosic fibrous ply” refers to a ply wherein the fibrous structure is predominantly (more than 50%) derived from cellulosic fibers.

Cellulosic fibers can be liberated from their source material by any one of a number of chemical pulping processes familiar to one experienced in the art including sulfate, sulfite, polysulfite, soda pulping, etc. The pulp can be bleached as desired by chemical means including the use of chlorine, chlorine dioxide, oxygen, etc. Alternatively, the cellulosic fibers can be liberated from source material by any one of a number of mechanical/chemical pulping processes familiar to anyone experienced in the art including mechanical pulping, thermomechanical pulping, and chemithermomechanical pulping. These mechanical pulps can be bleached, if one wishes, by a number of familiar bleaching schemes including alkaline peroxide and ozone bleaching.

The plies may be manufactured on any type of papermaking machine. In general, the production of paper plies and products occurs by one of three methods: (1) conventional wet press (CWP) with wet creping and embossing, as described in U.S. Pat. No. 5,048,589 (incorporated herein by reference in its entirety); (2) CWP with dry creping and embossing, as also described in U.S. Pat. No. 5,048,589 (incorporated herein by reference in its entirety); and (3) through-air-drying (TAD) with or without creping, as described in U.S. Pat. Nos. 3,301,746 and 3,905,863 (both incorporated herein by reference in their entireties).

In a typical process to form a ply, fibers are fed into a headbox where they are admixed with water and chemical additives, as appropriate, before being deposited on a forming wire before most of the liquid is removed. The resulting fibrous ply derives some of its structural integrity from the geometric and mechanical arrangement of the cellulosic fibers in the web; however, most of the fibrous ply's strength is derived from hydrogen bonding that links the cellulosic fibers to one another. The degree of strength imparted by this inter-fiber bonding, while necessary to the utility of the product, may result in a lack of perceived softness that is inimical to consumer acceptance.

One method of increasing the perceived softness of a paper product is to crepe the paper. Creping may occur by affixing the cellulosic web to a Yankee dryer with an adhesive or adhesive/release agent combination and then scraping the web off the Yankee with a creping blade. By breaking a significant number of inter-fiber bonds, creping adds to and increases the perceived softness of the paper product. Creping, Yankee dryers, adhesive agents, release agents, and creping blades are described in more detail in U.S. Pat. Nos. 5,961,782, 6,207,011, and 6,663,942, each of which is incorporated herein by reference in their entireties.

In conventional wet pressing, the nascent web is transferred to a papermaking felt and is dewatered by passing it between the felt and a press roll under pressure. The web is then pressed by a suction press roll against the surface of a rotating Yankee dryer cylinder that is heated to cause the paper to substantially dry on the cylinder surface. The moisture within the web as it is laid on the Yankee surface causes the web to transfer to the surface. Liquid adhesive may be applied to the surface of the dryer, as necessary, to provide substantial adherence of the web to the surface. The web is then removed from the Yankee surface with a creping blade. The creped web may then be passed between calendar rollers and may be rolled up to be used as a base sheet in the downstream production of a paper product. This method of making tissue sheets is commonly referred to as “wet-pressed” because of the compactive method used to dewater the wet web.

In some embodiments, the fibrous webs of the present invention may be formed by a conventional wet press (CWP) process. While one conventional wet pressing operation is described above, the process is only exemplary and variations on the described process will be readily apparent to the skilled artisan.

In through-air-drying (“TAD”) methods, the nascent web is partially dewatered using vacuum suction. Thereafter, the partially dewatered web is dried without compression by passing hot air through the web while it is supported by a through-drying fabric. However, as compared to conventional wet pressing, through-air-drying is expensive in terms of capital and energy costs. Because of the consumer perceived softness of these products and their greater ability to absorb liquid than webs formed in conventional wet press processes, the products formed by the through-air-drying process enjoy an advantage in consumer acceptance. Because it does not suffer from compaction losses, through-air-dried tissue base sheets currently exhibits the highest caliper, i.e., bulk, of any base sheet for use in premium absorbent products.

Variations on TAD include processes that use special fabrics or belts to impart a structure to the sheet, but which continue to use some limited nip load. In connection with the production of structured sheets, fabric molding has also been employed as a means to provide texture and bulk. In this respect, there is seen in U.S. Pat. No. 6,610,173 to Lindsay et al. a method for imprinting a paper web during a wet pressing event which results in asymmetrical protrusions corresponding to the deflection conduits of a deflection member. The '173 patent reports that a differential velocity transfer during a pressing event serves to improve the molding and imprinting of a web with a deflection member. The tissue webs produced are reported as having particular sets of physical and geometrical properties, such as a pattern densified network and a repeating pattern of protrusions having asymmetrical structures. With respect to wet-molding of a web using textured fabrics, see, also, the following U.S. Pat. Nos. 6,017,417 and 5,672,248 both to Wendt et al.; 5,505,818 and 5,510,002 to Hermans et al. and 4,637,859 to Trokhan. With respect to the use of fabrics used to impart texture to a mostly dry sheet, see U.S. Pat. No. 6,585,855 to Drew et al., as well as U.S. Pat. No. 6,607,638.

As used herein, “structured tissues” or “structured webs” refer to tissue made by TAD or other structured tissue technologies. These processes all share the characteristic that the sheet is dewatered under limited or no compaction.

In some embodiments, the fibrous webs of the present invention may be formed by a through-air-drying (TAD) process. While some conventional through-air-drying operations are described above, the processes are only exemplary and variations on the described processes will be readily apparent to the skilled artisan.

Additives for use in the formation of the fibrous cellulosic base sheet plies can be any known combination of papermaking chemicals. Such chemistry is readily understood by the skilled artisan and its selection will depend upon the type of end product that one is making. Additives include, for example, one or more of creping modifiers, softeners and debonders, sizing agents, retention agents, absorbency aids, strength agents, fillers, brighteners, optical whiteners, dyes, colorants, or starches, and the like.

The one or more additives may be introduced to the at least one ply at many or multiple points during the papermaking process. In some embodiments, one or more additives may be added to the stuffbox. In some embodiments, one or more additives may be added to the suction side of the machine chest pump. In some embodiments, one or more additives may be sprayed onto the web before the suction pressure roll. In some embodiments, one or more additives may be sprayed onto the ply before drying. In some embodiments, one or more additives may be added to the web during drying. In some embodiments, one or more additives may be sprayed onto the ply after drying. In some embodiments, additives may be added at many or multiple points during the papermaking process described above.

While exemplary formation of fibrous plies are detailed above, products using any fibrous plies can be used. The fibrous plies for use in the present disclosure can include those that are creped or uncreped, homogeneous or stratified, wet-laid or air-laid, and may contain up to 100% cellulose fibers.

In a typical process, after drying, the fibrous ply (base sheet) is rolled and awaits converting. While converting operations are generally carried out on rolled (reeled) paper plies, converting operations may also be added directly to the end of a papermaking process or processes without being rolled up first. Converting refers to the process that changes or converts base sheets into final products. Typical converting in the area of paper products according to the present disclosure may include calendaring, embossing, perforating, gluing, plying, slitting, rolling, and/or folding. The paper products disclosed herein may be subjected to any of the recognized converting operations that are readily apparent to the skilled artisan.

Embossing is the act of mechanically working a fibrous ply to cause the fibrous ply to conform under pressure to the depths and contours of a patterned embossing roll. In general, the ply is conveyed through an emboss nip between a pair of emboss rolls that, under pressure, form embossments within the surface of the ply. Unless indicated otherwise, “an emboss, (the noun)”, “embossing element,” “embossment,” “boss,” are all used herein interchangeably and refer to an element within an embossing pattern on a pattern roll that causes the base sheet to form protrusions or recessions in the fibrous ply, or to the protrusions or recessions in the plies themselves.

In most embossing configurations, at least one of the two roller surfaces directly carriers the emboss pattern to be transferred to the paper web or ply and may be referred to as a pattern roll. In some configurations, the opposing roll may be known as a backing roll. In some embodiments, the backing roll may have a relatively smooth surface that does not form noticeable impressions on the fibrous ply. In some embodiments, where two or more plies are joined within the embossing nip, the backing roll may be known as a marrying roll.

Pattern rolls may be rigid rolls comprising either a steel body that is directly engraved or a hard rubber coated surface (either directly coated or sleeved) that is laser engraved. While a directly engraved steel roll has a longer lifespan, its production may require significant lead time. Laser engraved sleeved rolls may require less production lead time, but often have a lifespan substantially less than that of a steel roll.

Backing rolls may be resilient rolls comprising a steel core directly coated or sleeved with a resilient material and may or may not be engraved with a pattern. If a pattern is present on the backing roll, the pattern may be either a mated, matched-mated, or a non-mated pattern with respect to the pattern carried on the rigid pattern roll. Backing rolls may also be rigid comprising an uncoated steel body, uncoated hard rubber or resin material, or a core coated with a hard rubber or resin material.

Known embossing configurations include rigid-to-resilient and rigid-to-rigid embossing. In a rigid-to-resilient embossing system, a single or multi-ply substrate is passed through a nip formed between a pattern roll, the substantially rigid surface of which contains the embossing pattern as a multiplicity of protuberances and/or depressions arranged into an aesthetically pleasing manner, and a backing roll, the substantially resilient surface of which may either be smooth or also contain a multiplicity of protuberances and/or depressions that cooperate with the rigid surfaced patterned roll.

In a rigid-to-rigid embossing system, a single-ply or multi-ply substrate is passed through a nip formed between two substantially rigid rolls. The surfaces of both rolls contain the pattern to be embossed as a multiplicity of protuberances and/or depressions arranged into an aesthetically pleasing manner. The protuberance and/or depressions of the two rolls cooperate with each other. Both rolls are generally comprised of either a steel body that is directly engraved or a hard rubber coated surface (either directly coated or sleeved) that is laser engraved.

Embossing patterns of the instant disclosure are made up of elements that may be arranged to create a design. The particular pattern may be chosen based on a myriad of considerations, including those that are functional as well as those that are non-functional aesthetic and ornamental. Emboss patterns for use in the instant disclosure may be or contain an indication of source of the paper product or may be or contain one or more design elements that are trademarks or other source identifiers.

Plying, ply bonding, or laminating is the act of joining two or more substrates. When the plies of the paper product are produced separately, the plies are plied together to form the paper product. Plying may be accomplished by several different techniques, including mechanical ply bonding of the plies, emboss ply bonding, and adhesive laminating the plies together. According to the present invention, the at least three cellulosic fibrous plies are bonded together by at least adhesive lamination, even if other forms of ply bonding may also be used.

According to the present methods, a first ply and a second ply are conveyed together through a first nip between an adhesive applicator roll and a second roll at line speed. As used here, the term “nip” between two rolls refers to the location where one or more plies pass between two adjacent rolls. As used herein, “line speed” refers to the speed at which fibrous plies move through the converting section of the papermaking machine, which may be determined by the speed of the rewinder at the beginning of the converting section where a rewinder is present. Line speed is measured in length per time (for example feet per minute or meters per minute).

According to the present methods, the nip between the adhesive applicator roll and the second roll has a gap between the two rolls of less than about 0.0035 inches. As used herein, the term “gap” (or “nip gap”) refers to the narrowest distance between the surfaces of the two rolls in the nip. In embodiments where the second roll includes embossments, the nip gap may be measured as the narrowest distance from the top of the embossment to the surface of the adhesive applicator roll. In some embodiments, the nip gap between the adhesive applicator roll and the second roll may be less than about 0.0035 inches, for example, less than about 0.003 inches, less than about 0.0025 inches, less than about 0.002 inches, less than about 0.0015 inches, less than about 0.001 inches, or less than about 0.0005 inches.

According to the present methods, an adhesive having a solids content of from about 6% to about 10% is transferred from an anilox roll to the adhesive applicator roll. In some embodiments, the adhesive may have a solids content from about 7% to about 9%. In some embodiments, the adhesive solids content may be about 7%. As used herein, the term “solids content” refers to the weight of the non-solvent, non-water ingredients in the adhesive divided by the total weight of the adhesive composition. It will be understood that solids content may be measured by a refractometer or similar instruments for solids content testing.

The adhesive may be any adhesive (e.g., glue) used for adhesive lamination known to one of ordinary skill in the art. In some embodiments, the adhesive may comprise a water-based synthetic resin. In some embodiments, the adhesive may comprise a polyamide-epichlorohydrin (PAE) resin. In some embodiments, the adhesive may comprise a polyvinyl alcohol (PVOH) polymer. In some embodiments, the adhesive may comprise a polyamideamine-epichlorohydrin (PAE) resin.

The adhesive may be transferred from an adhesive source to the anilox roll by any means known to one of ordinary skill in the art, such as from an adhesive bath (or reservoir) or a chamber (e.g., doctoring blade chamber), wherein the anilox roll rotates the surface of the roll into the adhesive bath or chamber to transfer adhesive from the bath to the surface of the anilox roll. According to the present invention, the solids content of the adhesive may be measured by the solids content of the adhesive in such an adhesive bath.

According to the present methods, the anilox roll is rotated at a speed from about 40% to about 100% of the line speed. In some embodiments, the anilox roll may be rotated at a speed from about 60% to about 90% of the line speed. In some embodiments, the anilox roll may be rotated at a speed from about 70% to about 80% of the line speed. In a preferred embodiment, the anilox roll may be rotated at a speed of about 75% of the line speed.

In some embodiments, the anilox roll can have a cell volume for accepting adhesive from the adhesive source from about 5 to about 25 billion cubic microns (BCM). Without wishing to be bound by theory, it is believed that increasing the cell volume of the anilox roll can allow the anilox roll to transfer more adhesive to the applicator roll and thus rotate at a slower speed. For example, according to some embodiments of the present invention, an 8 BCM anilox roll can rotate at about 75% of the line speed, but a 14 BCM anilox roll can rotate at about 40% of the line speed while maintaining a similar plybond strength as the 8 BCM anilox roll rotating at about 75% of the line speed.

Without wishing to be bound by theory, it is believed that, increasing the hardness of one or more of the backing and/or marrying rolls in combination with decreasing the anilox roll speed can allow for a wider nip gap while maintaining plybond strength. In some embodiments, a wider nip gap may be desirable to reduce wear on the rolls.

According to the present methods, the adhesive is transferred from the adhesive applicator roll to a first surface of the second ply at the first nip (the first surface being the surface of the second ply that is adjacent to the adhesive applicator roll), whereby some portion of the adhesive remains on the first surface of the second ply and some portion of the adhesive is driven though the width of the second ply to the second surface of the second ply.

According to the present methods, the adhesive that is driven though the width of the second ply to the second surface of the second ply forms a first adhesive bond between the first ply and the second ply.

According to the present methods, following exit from the first nip, the first and second cellulosic fibrous plies are then conveyed, along with a third cellulosic fiber ply, together through a second nip between the second roll and a third roll, wherein the third ply is adjacent to the second ply.

According to the present methods, some portion of the adhesive remaining on the first surface of the second ply forms a second adhesive bond between the second ply and the third ply.

According to the present methods, adhesive applicator roll and second roll form a first nip and are therefore interconnected and the second roll and the third roll form a nip and are therefore interconnected. The adhesive applicator roll, second roll, and third roll are therefore part of a single lamination stack.

In some embodiments, the second roll may be an embossing roll. In some embodiments, the second roll may be a backing roll. In some embodiments, the second roll may be a marrying roll.

In some embodiments, the third roll may be an embossing roll. In some embodiments, the third roll may be a backing roll. In some embodiments, the third roll may be a marrying roll.

In some embodiments, the lamination stack may have additional interconnected rolls. In some embodiments, the second roll may form a nip with a fourth roll. In some embodiments, the second roll may be a rigid embossing roll and form a nip with a fourth roll that is a resilient backing roll. In some embodiments, the second roll may be a resilient backing roll and form a nip with a fourth roll that is a rigid embossing roll. In some embodiments, the second roll and the fourth roll may form a nip and both be rigid embossing rolls.

In some embodiments, the third roll may form a nip with a fifth roll. In some embodiments, the third roll may be a rigid embossing roll and form a nip with a fifth roll that is a resilient backing roll. In some embodiments, the third roll may be a resilient backing roll and form a nip with a fifth roll that is a rigid embossing roll. In some embodiments, the third roll and the fifth roll may form a nip and both be rigid embossing rolls.

In some embodiments, either of the second or third rolls may further form a nip with a marrying roll between which the at least three plies may be conveyed following adhesive lamination in the second nip.

In some embodiments, the second roll can be a rigid roll, such as a steel roll. In some embodiments, the second roll can have a Rockwell C scale hardness number greater than about 40, for example, greater than about 50, greater than about 60, or greater than about 65.

In some embodiments, the third roll may be either a rigid or resilient roll. The Pusey and Jones (P&J) scale is one scale for measuring the hardness of rolls used in papermaking/converting, with a lower P&J number indicting a harder roll. In some embodiments, the third roll can have a hardness number smaller than about 45 P&J, for example smaller than about 6 P&J, or smaller than about 3. In some embodiments, the third roll can have a hardness number more than about 45 P&J, more than about 65 P&J or more than about 130 P&J.

In some embodiments with a fourth roll In some embodiments, the fourth roll can have a hardness number smaller than about 45 P&J, for example smaller than about 6 P&J, or smaller than about 3. In some embodiments, the fourth roll can have a hardness number more than about 45 P&J, more than about 65 P&J or more than about 130 P&J.

One of skill in the art would recognize other roll configurations that may be used in accordance with the methods herein.

In some embodiments, one or more of the at least three fibrous plies may be embossed. In some embodiments, at least two of the at least three fibrous plies may be embossed. In at least some embodiments, all three of the at least three fibrous plies are embossed.

In some embodiments, neither the first nor second fibrous plies may be embossed prior to the first nip. In some embodiments, the first fibrous ply may be embossed prior to the first nip. In some embodiments, the second fibrous ply may be embossed prior to the first nip. In some embodiments, both the first and second fibrous plies may be embossed prior to the first nip. In some embodiments, one of the first and second fibrous plies may be embossed in a nip between the second roll and a fourth roll prior to the first nip. In some embodiments, both the first and second fibrous plies may be embossed together in a nip between the second roll and a fourth roll prior to the first nip

In some embodiments, the first cellulosic fibrous ply may be adhesive laminated to the second cellulosic fibrous ply in a flat-to-flat configuration, in a tip-to-flat configuration, or a tip-to-tip configuration, depending on whether none, one, or both plies are embossed.

In some embodiments, neither the second nor third fibrous plies may be embossed prior to the second nip. In some embodiments, the second fibrous ply may be embossed prior to the second nip. In some embodiments, the third fibrous ply may be embossed prior to the second nip. In some embodiments, both the second and third fibrous plies may be embossed prior to the second nip.

In some embodiments, the first, second, and third plies may be embossed together in the second nip between the third roll and a fifth roll.

In some embodiments, the second cellulosic fibrous ply may be adhesive laminated to the third cellulosic fibrous ply in a flat-to-flat configuration, in a tip-to-flat configuration, or a tip-to-tip configuration, depending on whether none, one, or both plies are embossed.

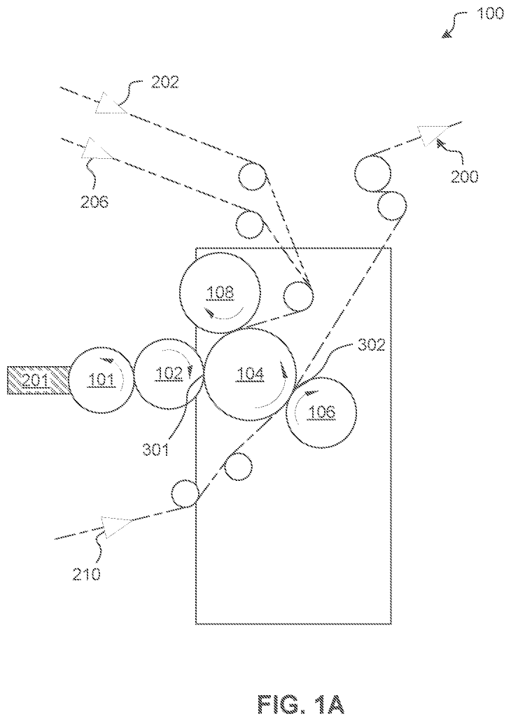

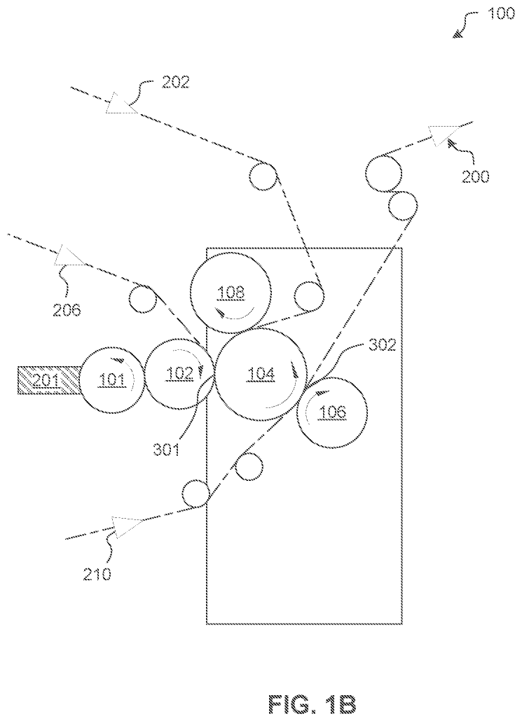

FIG. 1A shows an exemplary lamination stack 100. The lamination stack 100 can include an anilox roll 101, an adhesive applicator roll 102, a second roll 104, and a third roll 106. The lamination stack 100 can also include a fourth roll 108. In some embodiments, the anilox roll 101 may rotate from about 50% to about 100% of the line speed.

FIG. 1A shows that adhesive applicator roll 102 may receive adhesive 201 from an adhesive bath and may transfer the adhesive 201 to the surface of the second ply 206 facing the adhesive applicator roll 102. In some embodiments, the adhesive 201 may have a solids content of from about 6% to about 10%.

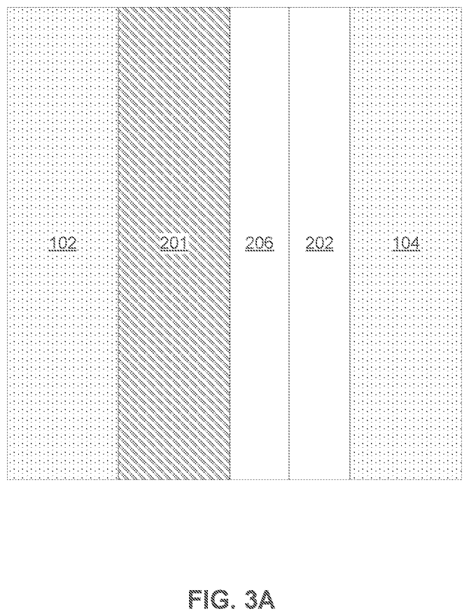

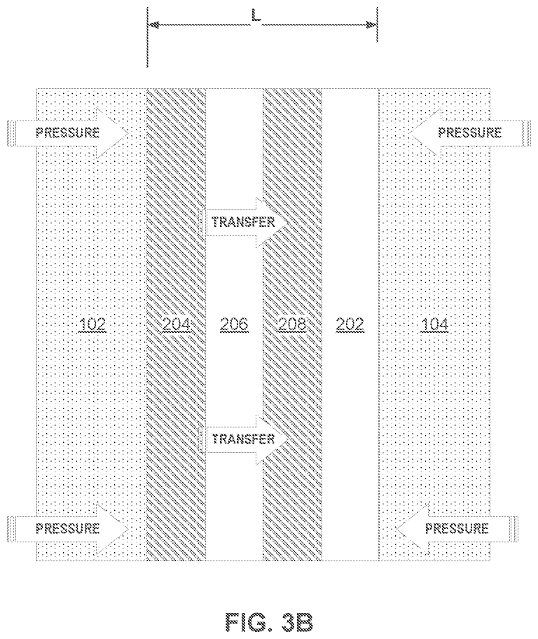

FIG. 1A shows a first ply 202, a second ply 206, and a third ply 210. In some embodiments, each ply may be conveyed through a nip. In some embodiments, a first ply 202 and the second ply 206 may be conveyed through a first nip 301 between the adhesive applicator roll 102 and the second roll 104. The first nip 301 may have a gap of less than about 0.0035 inches. In some embodiments, some portion of adhesive 201 may remain on the first surface of the second ply 206, and some portion of adhesive 201 may be transferred through the second ply 206 to the second surface of the second ply 206, as will be shown in FIGS. 3A and 3B. In some embodiments, the portion of adhesive 201 transferred though the second ply 206 to the second surface of the second ply 206 may contact the first ply 202, forming a first adhesive bond between the second ply 206 and the first ply 202. Additionally, prior to reaching the first nip 301, the first ply 202 and the second ply 206 may be conveyed through an emboss nip located between the fourth roll 108 and the second roll 104.

FIG. 1A shows the adhesive laminated first and second plies 202, 206 conveyed through a marrying nip 302 located between the second roll 104 and the third roll 106. Additionally, the third ply 210 may be conveyed through the marrying nip 302 together with the bonded first and second plies 202, 206. The portion of adhesive 201 remaining on the first surface of the second ply 206 may contact the third ply 210 at the marrying nip 302 and form a second adhesive bond between the second ply 206 and the third ply 210. A multi-ply paper product, such as the three-ply product 200 in FIG. 1A, may exit the marrying nip 302 and may be subjected to further processing.

In some embodiments, second roll 104 can be a steel emboss roll, and third roll 106 can be a marrying roll having a hardness of less than about 6 P&J. In some embodiments, the second roll 104 can be a steel emboss roll, and third roll 106 can be a marrying roll having a hardness of greater than about 65 P&J.

In some embodiments, following joinder of the plies, the converting process may comprise a slitter apparatus to cut the multi-ply paper product into multiple sheets.

In some embodiments, following slitting of the multi-ply paper product, the converting process may comprise a rolling apparatus, if the paper products to be made require rolling before packaging and/or shipment. This may be the case, for example, in the manufacture of rolled paper towel, pet wiper, or toilet tissue products.

In some embodiments, following slitting of the multi-ply paper product, the converting process may comprise a folder apparatus, if the paper products to be made require folding before packaging and/or shipment. This may be the case, for example, in the manufacture of folded napkin, wiper, or facial tissue products.

The multi-ply paper products according to the present disclosure may have varying attributes, depending on the type of final product being produced. Nevertheless, it is believed that the multi-ply paper products according to the present disclosure will exhibit at least an improved plybond between the first and second plies and between the second and third plies.

In some embodiments, the first adhesive bond between the first fibrous ply and the second fibrous ply may have a plybond from about 5 to about 50 grams force per three inches, for example, from about 11 to about 25 grams force per three inches, from about 13 to about 23 grams force per three inches, or from about 15 to about 21 grams force per three inches. In some embodiments, the first adhesive bond may be about 18 grams force per three inches.

In some embodiments, the second adhesive bond between the second fibrous ply and the third fibrous ply may have a plybond from about 5 to about 35 grams force per three inches, for example, from about 11 to about 25 grams force per three inches, from about 15 to about 21 grams force per three inches, or from about 17 to about 19 grams force per three inches. In some embodiments, the second adhesive bond may be about 18 grams force per three inches.

In some embodiments, the first adhesive bond and the second adhesive bond will have similar plybonds. Having similar plybonds between each layer of a multi-ply product is an attribute that is highly desirable by consumers. Such similarity in plybond between layers of a multiply product has not been achieved with multi-ply products made with prior single lamination stack processes. In some embodiments, the second bond may have a plybond of within (i.e., greater than or less than) about 20 grams force per 3 inches of the plybond of the first adhesive bond, for example within about 15 grams force per three inches, within about 10 grams force per three inches, within about 5 grams force per three inches, or within about 2 grams force per three inches of the plybond of the first bond.

Plybond may be measured using Thwing-Albert Model 2260 Friction/Peel Tester obtainable from Thwing-Albert Instrument Company, 14 W. Collings Avenue, West Berlin, NJ 08091, and a sample and platform clamp, obtainable from Research Dimensions, 1720 Oakridge Road, Neenah, WI 54956. The samples may be prepared by stacking three consecutive paper product sheets, and cutting a three inch wide strip though the center of the stack. Once the peel tester machine is calibrated, peel the three inch wide strip for approximately half an inch. Clamp the sample clamp on the on the peeled ply and “zero” the load cell of the sample clamp. Clamp the other plies on another sample clamp attached to the platform. Start the machine and the resultant load mean value is the plybond value.

The individual cellulosic fibrous plies may have basis weights of from about 5 to about 40 lbs/ream, which may be varied depending on the product to be produced. In some embodiments, the individual cellulosic fibrous plies may have basis weights of from about 5 to about 10 lbs/ream, from about 10 to about 20 lbs/ream, from about 20 to about 40 lbs/ream. In some embodiments, the individual cellulosic fibrous plies may have basis weights of from about 12 to about 18 lbs/ream, for example, from about 13 to about 16 lbs/ream. Unless otherwise specified, “basis weight”, “BWT,” “BW,” and so forth, refers to the weight of a 3000 square-foot ream of product. The basis weight may be measured under standard lab conditions (condition and test samples in an atmosphere of 23.0+/−1.0° C. (73.4+/−1.8° F.), 50%+/−2% R.H).

In some embodiments, the multi-ply paper product may have a caliper of from at least about 60 mils/8 sheets to about 300 mils/8 sheets, for example, from about 60 mils/8 sheets to about 100 mils/8 sheets, from about 100 mils/8 sheets to about 200 mils/8 sheets, from about 105 mils/8 sheets to about 130 mils/8 sheets, or from about 110 mils/8 sheets to about 125 mils/8 sheets. Unless otherwise specified, caliper may be measured at 8 sheets as follows. The sheets are stacked and the caliper measurement taken about the central portion of the stack. Preferably, the test samples are conditioned in an atmosphere of 23°±1.0° C. (73.4°±1.8° F.) at 50% relative humidity for at least about 2 hours and then measured with a Thwing-Albert Model 89-II-JR or Progage Electronic Thickness Tester with 2-in diameter anvils, 539+10 grams dead weight load, and 0.231 in/sec descent rate. For finished multi-ply product testing, each sheet of product to be tested must have the same number of plies as the product as sold. For testing in general, eight sheets are selected and stacked together. For rolled or folded product testing, the product should be unwound or unfolded prior to stacking.

In some embodiments, the multi-ply paper product may have a SAT capacity (also known as water absorption capacity) of from about 300 to about 800 g/m², for example, from about 300 to about 400 g/m², from about 400 to about 600 g/m², or from about 450 to about 550 g/m². Unless otherwise specified, SAT capacity may be measured with a simple absorbency tester. The simple absorbency tester is a particularly useful apparatus for measuring the hydrophilicity and absorbency properties of a sample of tissue, napkins, towel, and the like. In this test, a sample of the product (e.g., tissue, napkins, or towel) 2.0 inches in diameter is mounted between a top flat plastic cover and a bottom grooved sample plate. The product sample disc is held in place by a ⅛ inch wide circumference flange area. The sample is not compressed by the holder. De-ionized water at 73° F. is introduced to the sample at the center of the bottom sample plate through a 1 mm. diameter conduit. This water is at a hydrostatic head of minus 5 mm. Flow is initiated by a pulse introduced at the start of the measurement by the instrument mechanism. Water is thus imbibed by the tissue, napkin, or towel sample from this central entrance point radially outward by capillary action. When the rate of water imbibition decreases below 0.005 gm water per 5 seconds, the test is terminated. The amount of water removed from the reservoir and absorbed by the sample is weighed and reported as grams of water per square meter of sample or grams of water per gram of sheet.

In practice, an M/K Systems Inc. Gravimetric Absorbency Testing System is used. This is a commercial system obtainable from M/K Systems Inc., 12 Garden Street, Danvers, Mass., 01923. SAT capacity (also referred to as water absorbent capacity or WAC) is actually determined by the instrument itself. WAC is defined as the point where the weight versus time graph has a “zero” slope, i.e., the sample has stopped absorbing. The termination criteria for a test are expressed in maximum change in water weight absorbed over a fixed time period. This is basically an estimate of zero slope on the weight versus time graph. The program uses a change of 0.005 g over a 5 second time interval as termination criteria; unless “Slow SAT” is specified in which case the cut off criteria is 1 mg in 20 seconds.

FIG. 1B depicts another exemplary embodiment of lamination stack 100. In this embodiment, the second ply 206 is introduced into the first nip 301 without passing between second roll 104 and fourth roll 108, while the first ply 202 passes between the second roll 104 and fourth roll 108 before it is introduced into the first nip 301. The first and second plies 202, 206 are then bonded at the first nip 301, as discussed herein. The bonded first and second plies 202, 206 are bonded at a second nip 302 with the third ply 210, as discussed herein. In some embodiments, this configuration allows for the first ply 202 to be embossed between rolls 108 and 104 before entering the first nip, while the second ply 206 may enter the first nip without being embossed between rolls 108 and 104.

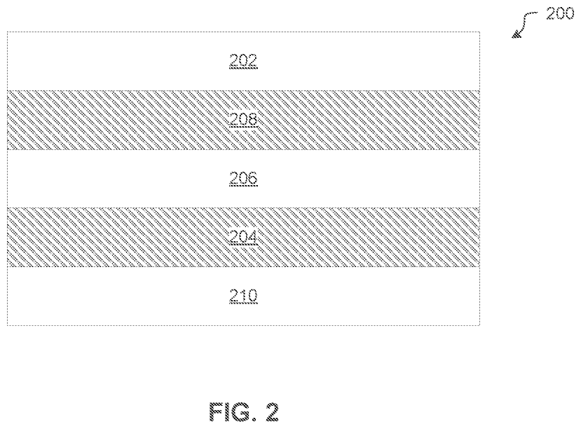

Turning to FIG. 2, multi-ply paper product 200 can include the first cellulosic fibrous ply 202 adhesively bonded to the second cellulosic fibrous ply 206 by a first adhesive bond. Where the product is formed by the methods disclosed herein, the first adhesive bond may be associated with the portion of adhesive 208 driven through the second ply 206 in the first nip between the adhesive applicator roll 102 and the second roll 104. The multi-ply paper product 200 can further include the third ply 210 adhesively bonded to the second ply 206 by a second adhesive bond. Where the product is formed by the methods disclosed herein, the second adhesive bond may be associated with the portion of adhesive 204 remaining on the first surface of the second ply 206. Though only three plies and two bonds are depicted here, additional bonds and plies are contemplated.

Turning to FIGS. 3A and 3B, those figures illustrate the adhesive transfer at the applicator nip, as discussed above. FIG. 3A illustrates adhesive applicator roll 102 having adhesive 201 thereon. The first and second plies 202, 206 are conveyed together through the first nip. Additionally, the second roll 104 may support the first and second plies 202, 206.

Turning to FIG. 3B, upon the adhesive applicator roll 102 and the second roll 104 may apply pressure, as depicted by the arrows labeled “PRESSURE”. Upon the pressure being applied, the adhesive 201, shown in FIG. 3A, is driven through the second ply 206 such that some portion (e.g., second portion of adhesive 208) transfers through the second ply 206 and contacts the first ply 202. The second portion of adhesive 208 may form a first bond, as discussed above in detail. Additionally, some portion of the adhesive 201 (e.g., first portion of adhesive 204), may remain on the second ply 206, between the adhesive applicator roll 102 and the second ply 206. This first portion of adhesive 204 may later form a second bond with the third ply 210 to form multi-ply paper product 200, as discussed above in detail. The dimension L may be the “gap” or “nip gap” as discussed above.

It is to be understood that the preceding description is exemplary and explanatory only and not restrictive of the invention, as claimed. The accompanying drawings, which are incorporated in and constitute a part of this specification, illustrate embodiments and together with the description, serve to explain the principles of the disclosure.

What is claimed is:

1. A method of manufacturing a multi-ply paper product comprising:
forming at least three cellulosic fibrous plies on a papermaking machine;
conveying a first ply and a second ply together through a first nip between an adhesive applicator roll and a second roll at a line speed, the nip having a gap between the two rolls of less than about 0.0035 inches;
transferring an adhesive having a solids content from about 6% to about 10% from an anilox roll to the adhesive applicator roll, wherein the anilox roll is rotated at a speed from about 40% to about 100% of the line speed;
transferring the adhesive from the adhesive applicator roll to a first surface of the second ply at the first nip, whereby some portion of the adhesive remains on the first surface of the second ply and some portion of the adhesive is driven though the width of the second ply to the second surface of the second ply and forms a first bond between the first ply and the second ply; and
conveying the first and second cellulosic fibrous plies and a third cellulosic fiber ply together through a second nip between the second roll and a third roll, whereby the third ply is adjacent to the second ply and some portion of the adhesive remaining on the first surface of the second ply forms a second bond between the second ply and the third ply.

2. The method of claim 1, wherein each of the at least three cellulosic fibrous plies has a basis weight from about 5 lbs/ream to about 32 lbs/ream.

3. The method of claim 1, wherein each of the at least three cellulosic fibrous plies has a basis weight from about 13 lbs/ream to about 16 lbs/ream.

4. The method of claim 1, wherein the at least three cellulosic fibrous are formed using a conventional wet-press (CWP) process.

5. The method of claim 1, wherein the at least three cellulosic fibrous are formed using a though air drying (TAD) process.

6. The method of claim 1, wherein the gap is less than about 0.002 inches.

7. The method of claim 1, wherein the gap is less than about 0.001 inches.

8. The method of claim 1, wherein the adhesive solid content is from about 6% to about 9%.

9. The method of claim 1 wherein the adhesive solid content is from about 7% to about 9%.

10. The method of claim 1, wherein the anilox roll is rotated at a speed from about 40% to about 75% of the line speed.

11. The method of claim 1 further comprising conveying a fourth ply together with the third though the second nip, whereby some portion of the adhesive is driven though the width of the third ply to a second surface of the third ply and forms a third bond between the third ply and the fourth ply.

12. The method of claim 1, wherein the first bond has a plybond within about 5 grams per 3 inches of the second bond.

13. The method of claim 1, wherein the first bond has a plybond within about 2 grams per 3 inches of the second bond.

14. The method of claim 1, wherein the product is one of a napkin, paper towel, toilet tissue, facial tissue, wiper, hand towel, or placemat.

15. The method of claim 1, wherein the product is a wiper.

16. The method of claim 1 wherein the third roll has a hardness number greater than about 65 P&J.

17. The method of claim 1 wherein the third roll has a hardness number smaller than about 6 P&J.

18. The method of claim 1, wherein the third roll has a hardness number smaller than about 6 P&J, the adhesive applicator roll has a cell volume from about 5 to about 25 BCM, the anilox roll is rotated from about 40% to about 75% of the line speed, and the first nip has a gap from about 0.001 to about 0.0035 inches.

19. The method of claim 1, wherein the third roll has a hardness number less than 3 P&J, the adhesive applicator roll has a cell volume from about 10 to about 20 BCM, the anilox roll is rotated from about 40% to about 60% of the line speed, and the first nip has a gap from about 0.0015 to about 0.0035 inches.

20. The method of claim 1, wherein the first roll has a hardness number less than 3 P&J, the adhesive applicator roll has a cell volume from about 12 to about 18 BCM, the anilox roll is rotated from about 45% to about 55% of the line speed, and the first nip has a gap from about 0.002 to about 0.0035 inches.

21. A multi-ply paper product comprising:
at least three cellulosic fibrous plies,
wherein a first ply and a second ply are bonded together by a first adhesive bond, wherein the first adhesive bond has a plybond from about 10 to about 20 grams force per 3 inches, and
wherein the second ply and a third ply are bonded together by a second adhesive bond, wherein the second adhesive bond has a plybond of within about 5 grams force per 3 inches of the plybond of the first adhesive bond.

22. The multi-ply paper product of claim 21, wherein the second adhesive bond has a plybond of within about 2 grams force per 3 inches of the plybond of the first adhesive bond.

23. The multi-ply paper product of claim 21, wherein the first and second bonds are formed by an adhesive having from about 6% to about 10% solid content.

24. The multi-ply paper product of claim 21, wherein each of the at least three cellulosic fibrous plies has a basis weight from about 5 lbs/ream to about 32 lbs/ream.

25. The multi-ply paper product of claim 21, wherein each of the at least three cellulosic fibrous plies has a basis weight from about 13 lbs/ream to about 16 lbs/ream.

26. The multi-ply paper product of claim 21, wherein at least one of the plies is produced by a conventional wet-press (CWP) process.

27. The multi-ply paper product of claim 21, wherein the at least one of the plies is produced by a though air drying (TAD) process.

28. The multi-ply paper product of claim 21, wherein the third ply is bonded together with a fourth ply to form a third bond.

29. The multi-ply paper product of claim 28, wherein the third bond has a plybond within about 5 grams per 3 inches of the first bond.

30. The multi-ply paper product of claim 21, wherein at least one of the plies is embossed.

31. The multi-ply paper product of claim 21, wherein at least two of the plies are embossed.

32. The multi-ply paper product of claim 21, wherein at least three of the plies is embossed.

33. The multi-ply paper product of claim 21, wherein the product is one of a napkin, paper towel, toilet tissue, facial tissue, wiper, hand towel, or placemat.

34. The multi-ply paper product of claim 21, wherein the product is a wiper.
